(19) United States
(12) Patent Application Publication
(10) Pub. No.: US 2026/0370175 A1
(43) Pub. Date: Nov. 19, 2026

(54) BALLASTED SOLAR MOUNTING SYSTEM

(71) Applicant: APA SOLAR, LLC, Ridgeville Corners, OH (US)

(72) Inventors: Todd Richard Schroeder, Napoleon, OH (US); Alexander Michael Basile, Ida, MI (US); Josh Von Deylen, Bryan, OH (US)

(21) Appl. No.: 19/680,378

(22) Filed: May 18, 2026

Related U.S. Application Data
(60) Provisional application No. 63/806,763, filed on May 16, 2025.

(51) Int. Cl. H02S 20/10

(52) U.S. Cl. CPC H02S 20/10

(57) ABSTRACT

A ballasted solar mounting system may include a basket body having a first end wall, a second end wall, a first side wall, a second side wall, and a base wall having an outer edge. The first end wall, the second end wall, the first side wall, and the second side wall may extend upwardly from the outer edge of the base wall. The basket body may include a coupling mechanism. The ballasted solar mounting system may include a tube system having a first vertical tube, a second vertical tube, a first telescoping tube slidingly engaged with the first vertical tube, and a second telescoping tube slidingly engaged with the second vertical tube. A cross tube may extend between the first vertical tube and the second vertical tube. The basket body and the tube system may be removably coupled to one another.

### CROSS-REFERENCE TO RELATED APPLICATIONS

This application claims the benefit of U.S. Provisional Application No. 63/806,763, filed on May. 16, 2025. The entire disclosure of the above application is incorporated herein by reference.

### FIELD

The present technology relates to mounting systems for solar installations, and, more particularly, to non-penetrating ballasted mounting systems for solar installations.

### INTRODUCTION

This section provides background information related to the present disclosure which is not necessarily prior art.

Solar power installations require secure solar mounting systems to support photovoltaic arrays. Many solar mounting systems are partially or wholly underground by design. However, certain installation sites may prohibit ground penetration due to a number of preexisting site conditions such as landfills, contaminated soil, or buried infrastructure. For installation sites with problematic preexisting site conditions, a ballasted solar mounting system may provide an optimal alternative mounting solution.

Ballasted solar mounting systems often require heavy material to secure the solar mounting system in place during operation. As an example, concrete ballast blocks may be used. However, concrete ballast blocks, whether pre-cast or poured on site, introduce significant logistical challenges and inefficiencies. For example, the process may require coordinating concrete truck deliveries, renting specialized pumping equipment, and managing on-site washout. Installation teams may be required to construct temporary concrete forms and wait extended periods of time for the material to cure before proceeding with subsequent solar installation steps.

Other issues relating to ballasted solar mounting systems relate to corrosion, lack of adjustability, costly shipping, and inefficient, difficult assembly, as examples. More specifically, materials used to construct ballasted solar mounting systems are often heavy and cumbersome to ship and handle during assembly. The materials and components often arrive unassembled, which can increase the cost and inefficiency of shipping due to a large number of unassembled separate parts and/or the shipping of large, awkwardly shaped components. The specialized components and materials may also require long-haul and extended-distance shipping, thereby increasing costs and environmental impact while simultaneously delaying assembly, installation, and operation of solar power installations. Certain ballasted solar mounting systems may be difficult to adjust and modify to meet site specific requirements during installation and operation and enhance solar power output.

Accordingly, there is a continuing need for a ballasted solar mounting system that is durable and corrosion-resistant, reduces assembly time and related complications, and optimizes solar output, while meeting manufacturing and site requirements. Desirably, such a ballasted solar mounting system is easily adjustable, at least partially pre-assembled, easy to set up, cost-efficient, and environmentally friendly.

### SUMMARY

In concordance with the instant disclosure, a ballasted solar mounting system that reduces assembly time and related complications, optimizes solar output, meets domestic manufacturing and site requirements, and is durable, corrosion-resistant, easily adjustable, at least partially pre-assembled, easy to set up, cost-efficient, and environmentally friendly, has surprisingly been discovered. The present technology includes articles of manufacture, systems, and processes that relate to ballasted solar mounting systems utilizing easy to ship and assemble pre-galvanized components with secure, adjustable coupling mechanisms that are configured for use with locally-sourced ballast material for securing solar power installations.

In certain embodiments, a ballasted solar mounting system may include a basket body having a first end wall, a second end wall configured to be disposed opposite the first end wall, a first side wall configured to be disposed between each of the first end wall and the second end wall, a second side wall configured to be disposed between each of the first end wall and the second end wall and opposite the first side wall, and a base wall having an outer edge. The first end wall, the second end wall, the first side wall, and the second side wall may be configured to extend upwardly from the outer edge of the base wall. A coupling mechanism may be configured to couple at least one of the first end wall, the second end wall, the first side wall, the second side wall, and the base wall to at least one other of the first end wall, the second end wall, the first side wall, the second side wall, and the base wall. The ballasted solar mounting system may include a tube system having a first vertical tube, a second vertical tube configured to be disposed opposite the first vertical tube, a first telescoping tube configured to slidingly engage with the first vertical tube, and a second telescoping tube configured to slidingly engage with the second vertical tube. A cross tube may be configured to extend between the first vertical tube and the second vertical tube. The basket body and the tube system may be configured to be removably coupled to one another.

In certain embodiments, a ballasted solar mounting system may include a basket body having a first end wall, a second end wall disposed opposite the first end wall, a first side wall disposed between each of the first end wall and the second end wall, a second side wall disposed between each of the first end wall and the second end wall and opposite the first side wall, and a base wall having an outer edge. The first end wall, the second end wall, the first side wall, and the second side wall may extend upwardly from the outer edge of the base wall. A coupling mechanism may couple at least one of the first end wall, the second end wall, the first side wall, the second side wall, and the base wall to at least one other of the first end wall, the second end wall, the first side wall, the second side wall, and the base wall. The ballasted solar mounting system may include a tube system having a first vertical tube, a second vertical tube disposed opposite the first vertical tube, a first telescoping tube slidingly engaged with the first vertical tube, and a second telescoping tube slidingly engaged with the second vertical tube. A cross tube may extend between the first vertical tube and the second vertical tube. The basket body and the tube system may be removably coupled to one another

In certain embodiments, a method of assembling a ballasted solar mounting system may include a first step of providing a ballasted solar mounting system. The ballasted solar mounting system may include a basket body in a flat configuration having a first end wall, a second end wall configured to be disposed opposite the first end wall, a first side wall configured to be disposed between each of the first end wall and the second end wall, a second side wall configured to be disposed between each of the first end wall and the second end wall and opposite the first side wall, and a base wall having an outer edge. The first end wall, the second end wall, the first side wall, and the second side wall may be configured to extend upwardly from the outer edge of the base wall. A coupling mechanism may be configured to couple at least one of the first end wall, the second end wall, the first side wall, the second side wall, and the base wall to at least one other of the first end wall, the second end wall, the first side wall, the second side wall, and the base wall. The ballasted solar mounting system may include a tube system having a first vertical tube, a second vertical tube configured to be disposed opposite the first vertical tube, a first telescoping tube configured to slidingly engage with the first vertical tube, a second telescoping tube configured to slidingly engage with the second vertical tube, and a cross tube configured to extend between the first vertical tube and the second vertical tube. Additional steps may include unfolding the basket body, installing a second coupling mechanism, coupling the first vertical tube to the first end wall and the second vertical tube to the second end wall, and coupling the cross tube to the first vertical tube and the second vertical tube. Further steps may include coupling the first telescoping tube to the first vertical tube and the second telescoping tube to the second vertical tube, coupling the cross member to the first telescoping tube and the second telescoping tube, and coupling the mounting element to the first telescoping tube and the second telescoping tube.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a ballasted solar mounting system according to an embodiment of the present disclosure;

FIG. 2 is a front elevational view of the ballasted solar mounting system of FIG. 1;

FIG. 3 is a side elevational view thereof;

FIG. 4 is a perspective view of a ballasted solar mounting system, according to an embodiment of the present disclosure;

FIG. 5A is a perspective view of a basket body of a ballasted solar mounting system, according to an embodiment of the present disclosure, the basket body depicted in a flat configuration;

FIG. 5B is a perspective view of the basket body of FIG. 5A, the basket body shown in a partially assembled configuration;

FIG. 6 is a ballasted solar mounting system depicted in use with a solar interface system, according to an embodiment of the present disclosure;

FIG. 7 is an exploded perspective view of a tube system of a ballasted solar mounting system, according to an embodiment of the present disclosure;

FIG. 8 is a schematic diagram of a ballasted solar mounting system, according to an embodiment of the present disclosure;

FIG. 9 is a flow diagram of a method of assembling a ballasted solar mounting system; and

FIG. 10 is a flow diagram of a method of using a ballasted solar mounting system.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves upon ballasted solar mounting systems by providing preassembled and easy to assemble components and utilizing cost efficient materials, thereby decreasing installation time and overall cost. The present technology optimizes solar output by including adjustable components configured for use above ground on installation sites that may have preexisting site conditions such as landfills, contaminated soils, or buried infrastructure. Additionally, the present technology reduces shipping costs and environmental impact with efficiently packaged components and materials, reduced shipping distances, and locally obtained ballast material.

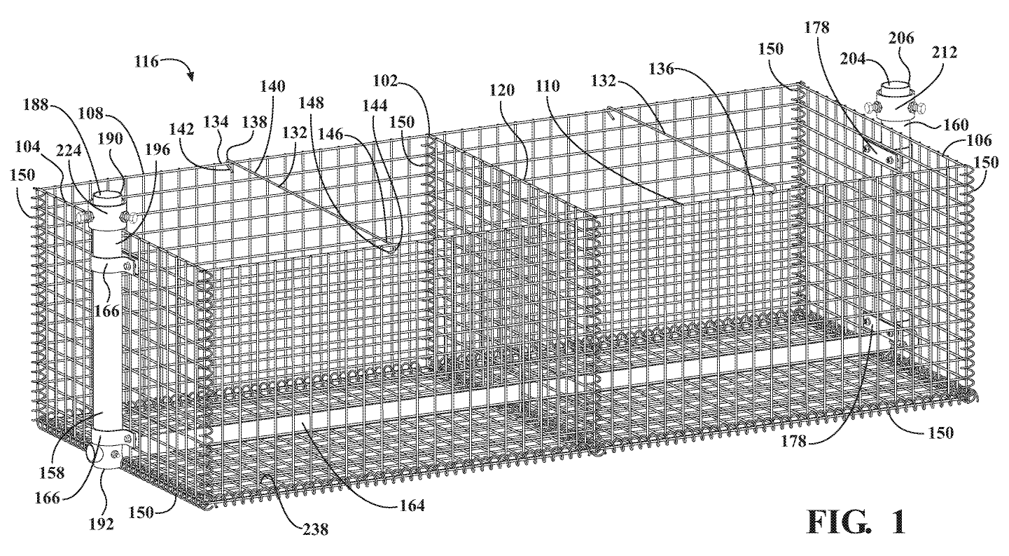

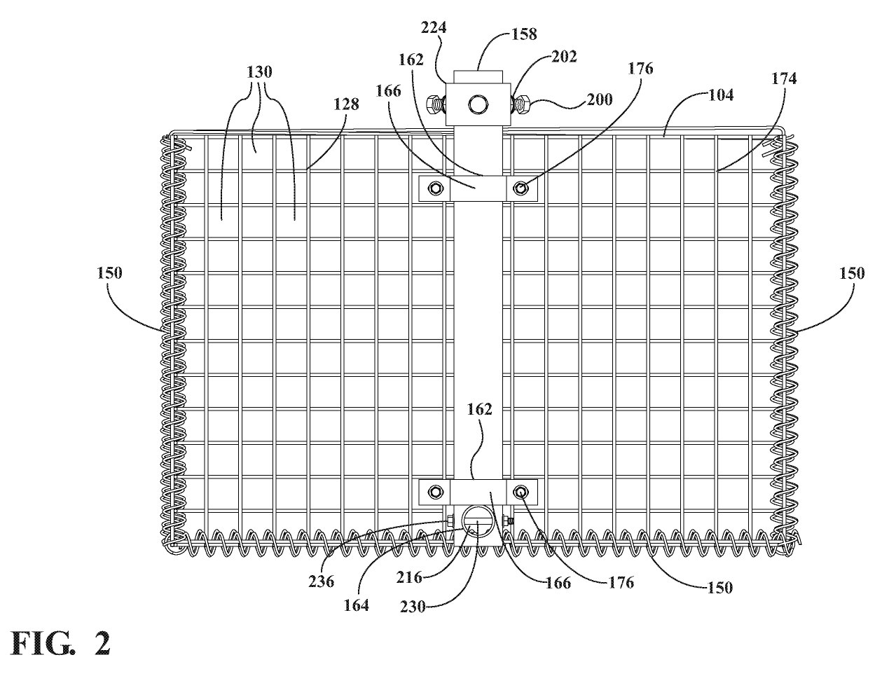

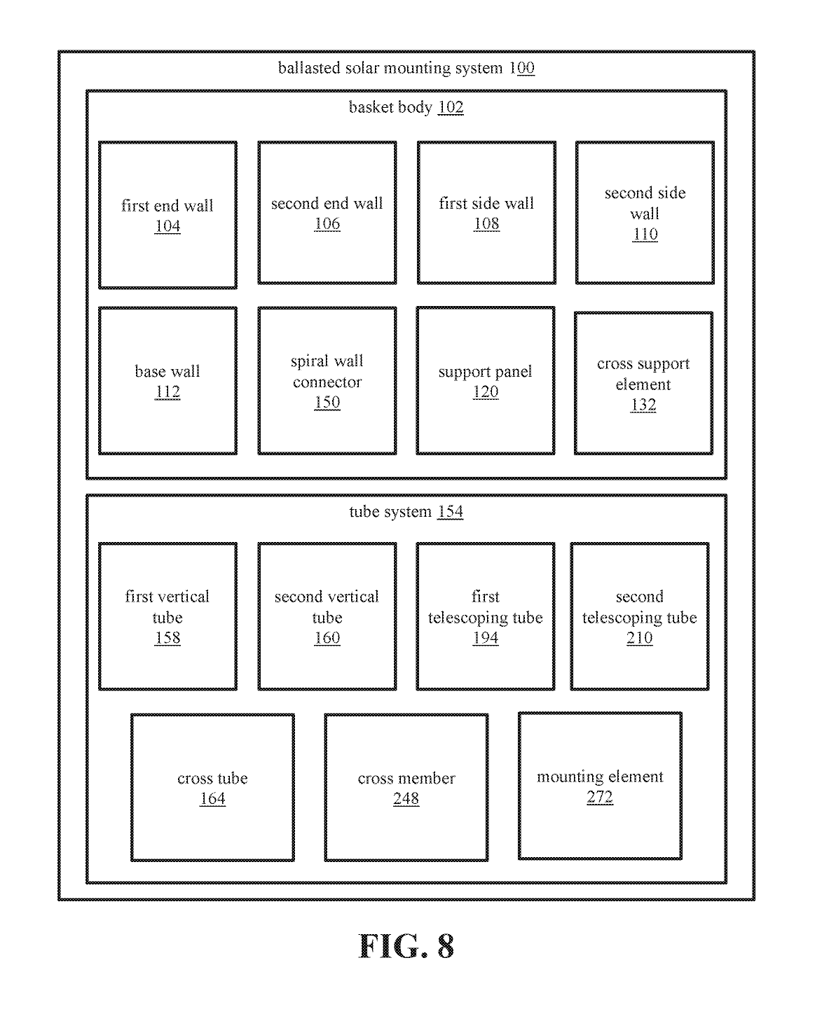

With reference to FIGS. 1-8, aspects of a ballasted solar mounting system 100 are shown. The ballasted solar mounting system 100 may be configured to provide a non-penetrating mounting solution for solar installations where ground penetration may be suboptimal or prohibited, such as on landfills, sites with contaminated soil, areas with buried infrastructure, or where a non-penetrating mounting solution may be preferred. The ballasted solar mounting system 100 may include a basket body 102. The basket body 102 may include a first end wall 104, a second end wall 106 disposed opposite the first end wall 104, a first side wall 108 disposed between each of the first end wall 104 and the second end wall 106, a second side wall 110 disposed between each of the first end wall 104 and the second end wall 106 and opposite the first side wall 108, and a base wall 112. Each of the first and second end walls 104, 106 and the first and second side walls 108, 110 may be configured to extend upwardly from an outer edge 114 of the base wall 112 when in an assembled configuration 116. Each of the first and second end walls 104, 106, the first and second side walls 108, 110, and the base wall 112 may define a generally rectangular shape including an opening 118 that may be configured to receive a ballast material (not shown). A skilled artisan may select any suitable shape, size, and configuration for the basket body 102 within the scope of the present disclosure.

The ballasted solar mounting system 100 may include a support panel 120 disposed between the first end wall 104 and the second end wall 106 and configured to extend from the first side wall 108 to the second side wall 110. The support panel 120 may be configured to provide enhanced structural support for the basket body 102. The support panel 120 may be configured to divide the basket body 102 into one or more sections 122. In certain embodiments, a first section 124 of the basket body 102 may be defined by the first end wall 104, the support panel 120, and a portion of each of the first side wall 108, the second side wall 110, and the base wall 112. A second section 126 of the basket body 102 may be defined by the second end wall 106, the support panel 120, and a portion of each of the first side wall 108, the second side wall 110, and the base wall 112. The first section 124 and the second section 126 may be identical to one another or may be different. It should be appreciated that more than one support panel 120 may be included with the ballasted solar mounting system 100 in order to provide enhanced structural support for the basket body 102. A plurality of support panels 120 may be used to divide the basket body 102 into a plurality of sections 122.

Each of the first and second end walls 104, 106, the first and second side walls 108, 110, the base wall 112, and the support panel 120 may be fabricated using a durable, fixed material such as metal. The material may be a pre-galvanized material and may be formed into a wire sheet 128 having a mesh structure or grid-like pattern, according to certain embodiments. The wire sheet 128 may include a plurality of wire openings 130 and the wire openings 130 may be any desirable shape and size capable of containing the ballast material. In certain embodiments, a galvanized steel wire welded together to form the wire sheet 128 may be utilized. The wire sheet 128 of each of the first and second end walls 104, 106, the first and second side walls 108, 110, the base wall 112, and the support panel 120 may include a polyvinyl chloride (PVC) coating for enhanced durability and improved aesthetics. It should be appreciated that any strong, durable, cost-effective, corrosion-resistant material, coating, and combinations thereof suitable for corrosive environments and maintaining a desired shape during operation may be employed to fabricate the basket body 102, as determined by a skilled artisan.

The ballasted solar mounting system 100 may include one or more cross support elements 132 configured to be coupled to one or more of the first end wall 104, the second end wall 106, the first side wall 108, the second side wall 110, the base wall 112, and the support panel 120. The cross support element 132 may be fabricated using a pre-galvanized steel wire and may include a PVC coating, according to certain embodiments. It should be appreciated that any suitable material or combination of materials may be used to fabricate the cross support element 132, as determined by a skilled artisan. As an example, the cross support element 132 may be an elongated, fixed component configured to extend from a first upper edge 134 of the first side wall 108 to a second upper edge 136 of the second side wall 110. The cross support element 132 may include a first coupling element 138 disposed at a first end 140 of the cross support element 132 configured as a first hook 142 and a second coupling element 144 disposed at a second end 146 of the cross support element 132 configured as a second hook 148, as an example. The first hook 142 and the second hook 148 may be configured to couple to the first upper edge 134 and the second upper edge 136, respectively. Any suitable shape, size, and configuration may be utilized for the cross support element 132 and the cross support element 132 may be configured to couple to the basket body 102 using any suitable coupling mechanism, as determined by one of skill in the art.

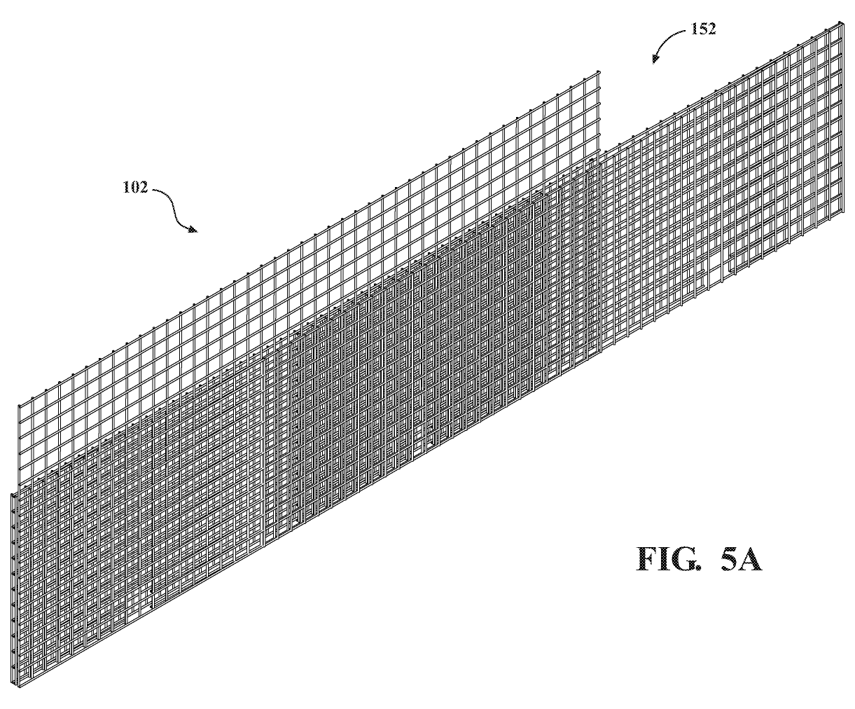

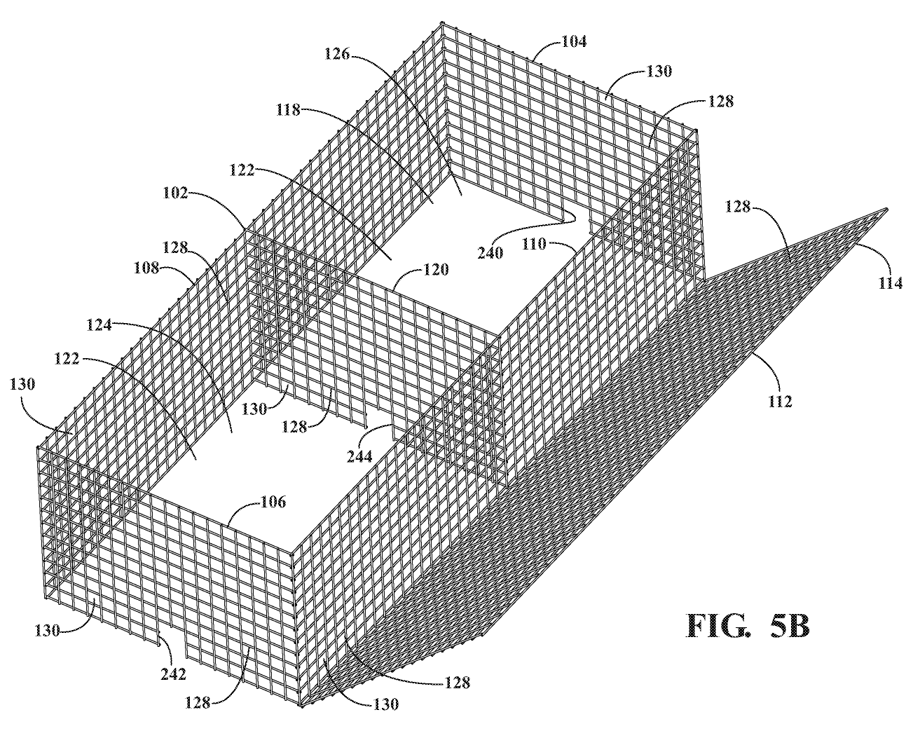

One or more of the first and second end walls 104, 106, the first and second side walls 108, 110, the base wall 112, and the support panel 120 may be coupled to one another using any suitable coupling mechanism such as a spiral wall connector 150, as an example. The spiral wall connector 150 may be configured to couple one or more of the first and second end walls 104, 106, the first and second side walls 108, 110, the base wall 112, and the support panel 120 to one another while permitting a hinging or rotating motion of one or more of the first and second end walls 104, 106, the first and second side walls 108, 110, the base wall 112, and the support panel 120 relative to one another, thereby enabling the basket body 102 to be folded in a generally flat configuration 152, as shown in FIG. 5A, for shipping and storage while maintaining structural integrity when the basket body 102 is arranged in the assembled configuration 116, as shown in FIGS. 1, 4 and 6. In certain embodiments, the spiral wall connector 150 may be fabricated using a pre-galvanized steel wire and may include a PVC coating, however, any suitable material, coating, or combinations thereof may be used. It should be appreciated that any suitable coupling mechanism may be employed such as quick-latch connectors, clamp couplers, and various fasteners, as examples.

With reference now to FIGS. 1-4, 6 and 7, the ballasted solar mounting system 100 may include a tube system 154, to couple to and support a solar interface system 156. The tube system 154 may be fabricated using any durable, corrosion resistant material or combination of materials such as aluminum alloy, pre-galvanized steel, and galvanized steel, as examples. In certain embodiments, the tube system 154 may include a first vertical tube 158 and a second vertical tube 160 configured to be positioned opposite the first vertical tube 158. The first vertical tube 158 and the second vertical tube 160 may be disposed substantially centrally adjacent the first end wall 104 and the second end wall 106, respectively, in the assembled configuration 116. Each of the first and second vertical tubes 158, 160 may be coupled to the first end wall 104 or the second end wall 106 using any suitable vertical tube coupling mechanism 162 such as one or more brackets and/or one or more fasteners, as examples. The tube system 154 may include a cross tube 164 configured to couple to each of the first vertical tube 158 and the second vertical tube 160.

In certain embodiments, the vertical tube coupling mechanism 162 may include a first bracket 166 having a first flat strap 168 configured to abut an interior surface 170 of the first end wall 104, a first curved strap 172 configured to abut the first vertical tube 158 and an exterior surface 174 of the first end wall 104, and one or more bracket fasteners 176 configured to couple the first flat strap 168 and the first curved strap 172. The first curved strap 172 may be configured to couple to the first vertical tube 158 and the one or more bracket fasteners 176 may extend through the first curved strap 172, the first end wall 104, and the first flat strap 168 to secure the first vertical tube 158 adjacent the exterior surface 174 of the first end wall 104.

The vertical tube coupling mechanism 162 may include a second bracket 178 having a second flat strap 180 configured to abut an interior surface 182 of the second end wall 106, a second curved strap 184 configured to abut the second vertical tube 160 and an exterior surface 186 of the second end wall 106, and one or more bracket fasteners 176 configured to couple the second flat strap 180 and the second curved strap 184. The second curved strap 184 may be configured to couple to the second vertical tube 160 and the one or more bracket fasteners 176 may extend through the second curved strap 184, the second end wall 106, and the second flat strap 180 to secure the second vertical tube 160 adjacent the exterior surface 186 of the second end wall 106. It should be appreciated that more than one first bracket 166 and/or more than one second bracket 178 may be employed.

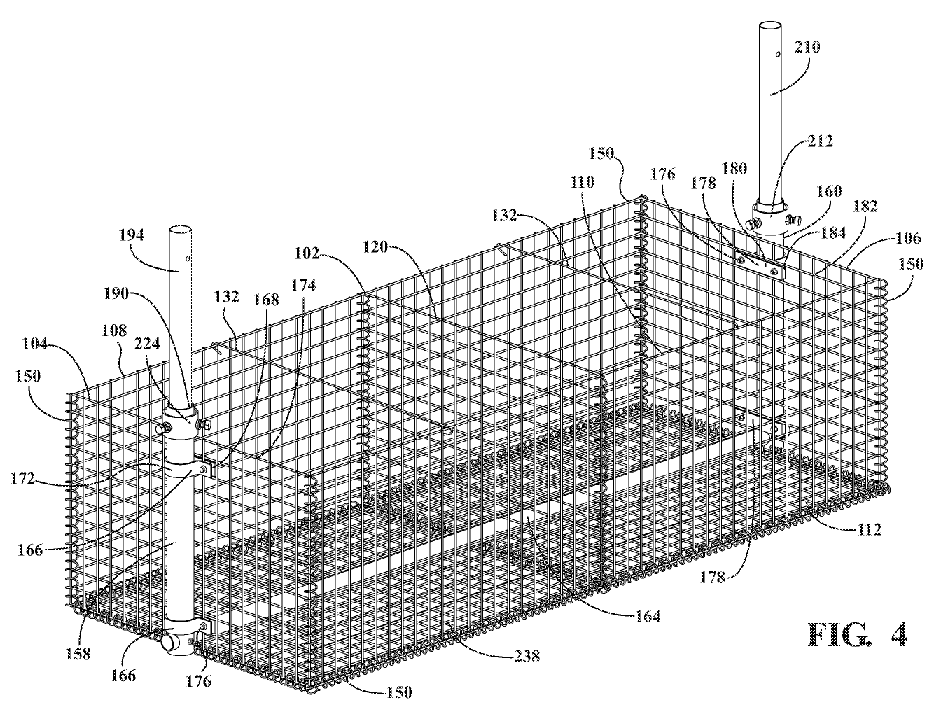

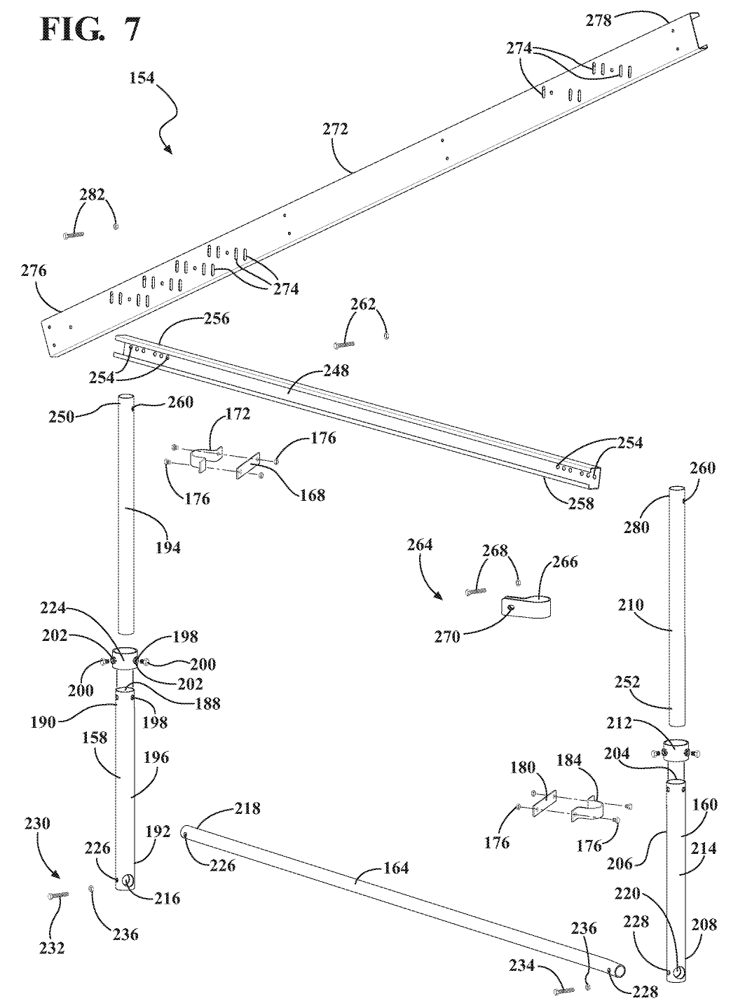

With continued reference to FIGS. 4 and 7, the first vertical tube 158 may include a first channel 188 extending from a first end 190 of the first vertical tube 158 to a second end 192 of the first vertical tube 158 disposed opposite the first end 190 of the first vertical tube 158. The first channel 188 may be configured to slidingly receive a first telescoping tube 194 at the first end 190 of the first vertical tube 158. A first support element 224 may be disposed around an outer surface 196 of the first vertical tube 158 adjacent the first end 190 of the first vertical tube 158. Each of the first vertical tube 158 and the first support element 224 may include one or more telescoping tube apertures 198 configured to align with one another in the assembled configuration 116. Each telescoping tube aperture 198 may be configured to receive a telescoping tube fastener 200 such as a bolt, as an example, configured to secure the first telescoping tube 194 in position relative to the first vertical tube 158 and the first support element 224. In certain embodiments, each telescoping tube aperture 198 of one or both of the first support element 224 and the first vertical tube 158 may include a threaded element 202 configured to threadedly receive the telescoping tube fastener 200. The telescoping tube fastener 200 may be configured to extend through the telescoping tube aperture 198 of the first support element 224 and the first vertical tube 158 and secure the first telescoping tube 194 in place relative to the first vertical tube 158 using any suitable coupling mechanism such as a friction fit or a threaded fit, as examples. The first support element 224 may be integrally formed with the first vertical tube 158 or coupled thereto, as determined by one of skill in the art. It should be appreciated that each of the first and second telescoping tubes 194, 210 may be telescopically height adjustable to accommodate site-specific requirements and enhance the output of the solar interface system 156.

The second vertical tube 160 may include a second channel 204 extending from a first end 206 of the second vertical tube 160 to a second end 208 of the second vertical tube 160 disposed opposite the first end 206 of the second vertical tube 160. The second channel 204 may be configured to slidingly receive a second telescoping tube 210 at the first end 206 of the second vertical tube 160. A second support element 212 may be disposed around an outer surface 214 of the second vertical tube 160 adjacent the first end 206 of the second vertical tube 160. Each of the second vertical tube 160 and the second support element 212 may include one or more telescoping tube apertures 198 configured to align with one another in the assembled configuration 116. Each telescoping tube aperture 198 may be configured to receive a telescoping tube fastener 200 such as a bolt, as an example, configured to secure the second telescoping tube 210 in position relative to the second vertical tube 160 and the second support element 212. In certain embodiments, each telescoping tube aperture 198 of one or both of the second support element 212 and the second vertical tube 160 may include a threaded element 202 configured to threadedly receive the telescoping tube fastener 200. The telescoping tube fastener 200 may be configured to extend through the telescoping tube aperture 198 of the second support element 212 and the second vertical tube 160 and secure the second telescoping tube 210 in place relative to the second vertical tube 160 using any suitable coupling mechanism such as a friction fit or a threaded fit, as examples. The second support element 212 may be integrally formed with the second vertical tube 160 or coupled thereto, as determined by one of skill in the art.

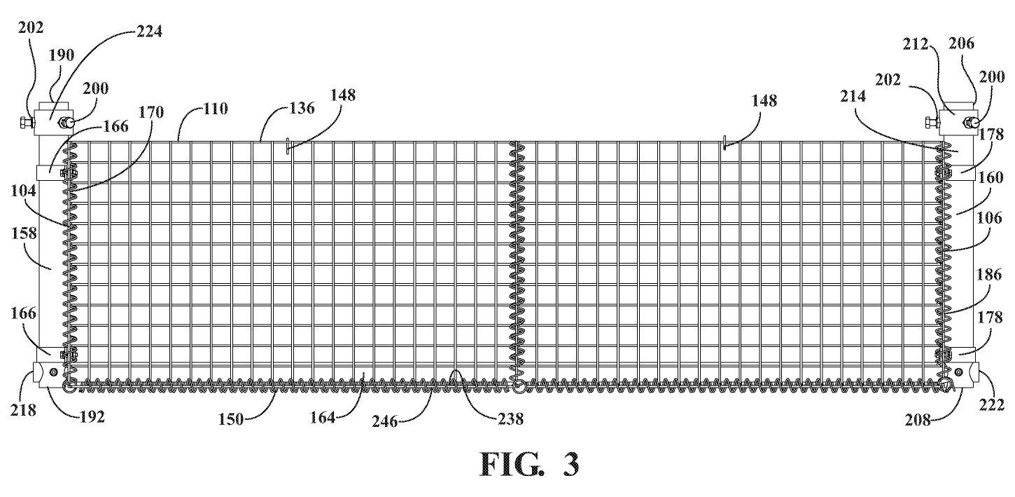

The cross tube 164 of the tube system 154 may be configured to extend from the second end 192 of the first vertical tube 158 to the second end 208 of the second vertical tube 160, as shown in FIG. 3. As shown in FIG. 7, in certain embodiments, the second end 192 of the first vertical tube 158 may include one or more first cross tube openings 216 configured to receive a first end 218 of the cross tube 164, and the second end 208 of the second vertical tube 160 may include one or more second cross tube openings 220 configured to receive a second end 222 of the cross tube 164. The cross tube 164 may be coupled to the first and second vertical tubes 158, 160 using any suitable coupling mechanism. As an example, each of the first end 218 of the cross tube 164 and the second end 192 of the first vertical tube 158 may include a first pair of cross tube apertures 226 disposed opposite one another and configured to align with one another in the assembled configuration 116. Each of the second end 222 of the cross tube 164 and the second end 208 of the second vertical tube 160 may include a second pair of cross tube apertures 228 disposed opposite one another and configured to align with one another in the assembled configuration 116. Each of the first and second pairs of cross tube apertures 226, 228 may be configured to receive a cross tube fastener 230 such as a double-end threaded rod, as an example. In certain embodiments, a first cross tube fastener 232 may extend through the first pair of cross tube apertures 226 and a second cross tube fastener 234 may extend through the second pair of cross tube apertures 228. Each of the first and second cross tube fasteners 232, 234 may be secured using any suitable cross tube securing mechanism 236 such as one or more nuts removably and threadedly coupled to the ends of each of the first and second cross tube fasteners 232, 234, as examples, thereby militating against movement of the cross tube 164 relative to the first and second vertical tubes 158, 160.

The cross tube 164 may be configured to extend along the base wall 112 and, in certain embodiments, may be disposed adjacent an inner surface 238 of the base wall 112. The first end 218 of the cross tube 164 may extend through a first cutout 240 formed in the first end wall 104 and the second end 222 of the cross tube 164 may extend through a second cutout 242 formed in the second end wall 106. The cross member 164 may extend through a third cutout 244 formed in the support panel 120. It should be appreciated that, in the assembled configuration 116, the first cutout 240, the second cutout 242, and the third cutout 244 may be aligned and configured to receive the cross tube 164, thereby allowing the cross tube 164 to be positioned within the basket body 102 and the basket body 102 to maintain a flat bottom surface 246 of the base wall 112 in the assembled configuration 116. The ballast material may militate against movement of the basket body 102 and the tube system 154 during operation.

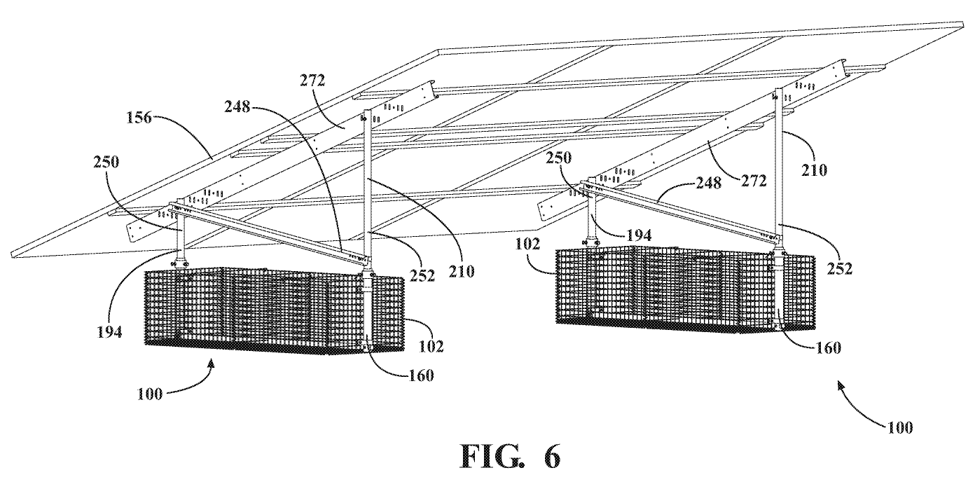

As shown in FIGS. 6 and 7, the tube system 154 may include a cross member 248 extending from the first telescoping tube 194 to the second telescoping tube 210. In certain embodiments, the cross member 248 may be configured to extend from a first end 250 of the first telescoping tube 194 adjacent the solar interface system 156 to a second end 252 of the second telescoping tube 210 adjacent the basket body 102. The cross member 248 may be configured to provide enhanced structural integrity to the tube system 154 during installation and operation.

Any suitable coupling mechanism or coupling mechanisms may be employed to couple the cross member 248 to each of the first telescoping tube 194 and the second telescoping tube 210. As an example, the cross member 248 may have a plurality of cross member coupling apertures 254 disposed at each of a first end 256 of the cross member 248 and a second end 258 of the cross member 248. The cross member coupling apertures 254 at the first end 256 of the cross member 248 may be configured to align with one or more telescoping tube openings 260 disposed at the first end 250 of the first telescoping tube 194 adjacent the solar interface system 156. The first end 256 of the cross member 248 and the first end 250 of the first telescoping tube 194 may be secured to one another using any suitable first cross member coupling mechanism 262 such as a combination of nuts and bolts configured to extend through each of the cross member coupling apertures 254 and the telescoping tube openings 260, as an example. A second cross member coupling mechanism 264 may include a cross member bracket 266 removably or adjustably disposed around the second telescoping tube 210. The cross member bracket 266 may be configured to couple to the second telescoping tube 210 using a friction fit, as an example. In certain embodiments, the cross member bracket 266 may be integrally formed with the second telescoping tube 210. A cross member fastener 268 may be configured to extend through a cross member bracket aperture 270 formed in the cross member bracket 266 and the cross member coupling aperture 254 at the second end 258 of the cross member 248, thereby securing the cross member 248 to the cross member bracket 266 and the second telescoping tube 210. It should be appreciated that any suitable coupling mechanism or combination of coupling mechanisms may be employed, as determined by one of skill in the art.

The tube system 154 may further include a mounting element 272 configured to couple each of the first and second telescoping tubes 194, 210 to the solar interface system 156, as shown in FIG. 7. The mounting element 272 may have a plurality of mounting element coupling apertures 274 disposed along each of a first end 276 of the mounting element 272 and a second end 278 of the mounting element 272. The mounting element coupling apertures 274 at the first end 276 of the mounting element 272 may be configured to align with one or more telescoping tube openings 260 disposed at the first end 250 of the first telescoping tube 194 adjacent the solar interface system 156, and the mounting element coupling apertures 274 at the second end 278 of the mounting element 272 may be configured to align with one or more telescoping tube openings 260 disposed at a first end 280 of the second telescoping tube 210 adjacent the solar interface system 156. The mounting element 272 and each of the first and second telescoping tubes 194, 210 may be adjustably coupled to one another using any suitable mounting element coupling mechanism 282 such as a combination of nuts and bolts configured to extend through the mounting element coupling apertures 274 and the telescoping tube openings 260, as an example.

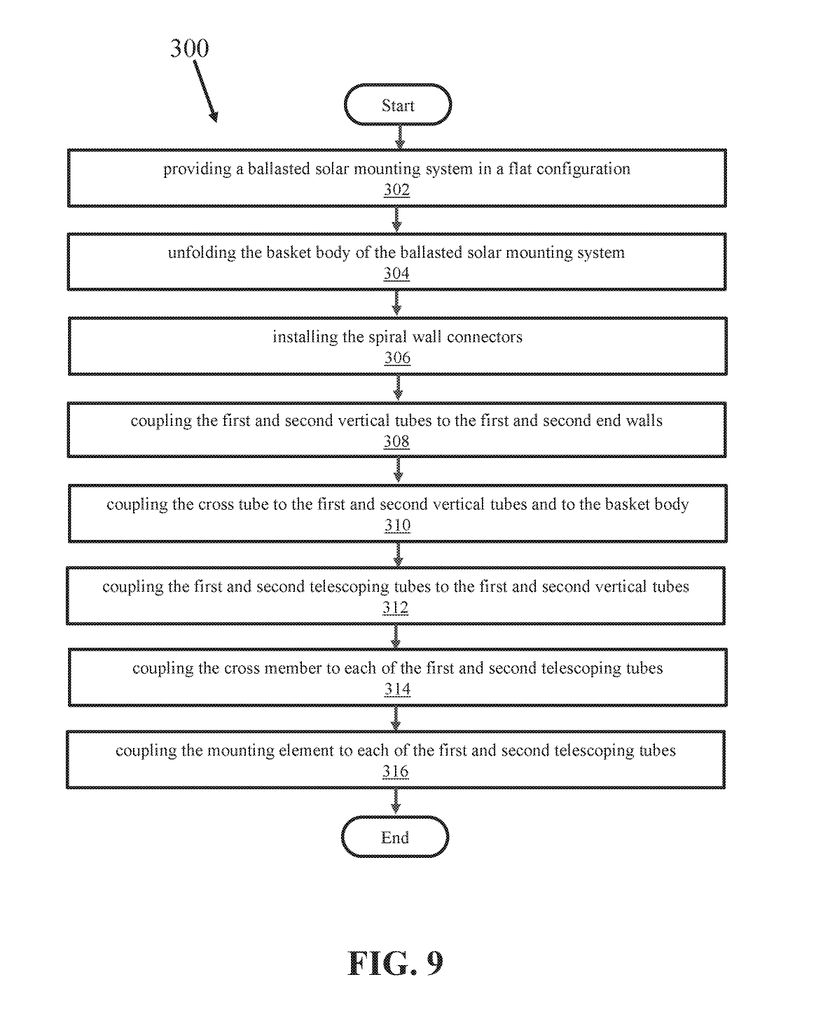

A method 300 of assembling a ballasted solar mounting system 100 is provided, as shown in FIG. 9. The method 300 may include a step 302 of providing the ballasted solar mounting system 100, as shown and described herein, including the basket body 102 and the tube system 154 of the ballasted solar mounting system 100 in the flat configuration 152. A second step 304 may include unfolding the basket body 102 using the hinges formed by the preassembled spiral wall connectors 150, and a third step 306 may include installing additional spiral wall connectors 150 to secure the basket body 102 in the assembled configuration. In a fourth step 308, each of the first and second vertical tubes 158, 160 may be coupled to the first and second end walls 104, 106, respectively. The cross tube 164 may be coupled to each of the first and second vertical tubes 158, 160 and the basket body 102 in a fifth step 310. In a sixth step 312, each of the first and second telescoping tubes 194, 210 may be coupled to the first and second vertical tubes 158, 160, respectively. In a seventh step 314, the cross member 248 may be coupled to each of the first and second telescoping tubes 194, 210, and in an eighth step 316, the mounting element 272 may be coupled to each of the first and second telescoping tubes 194, 210.

It should be appreciated that when the basket body 102 is in the flat configuration 152, the spiral wall connectors 150 may be preinstalled between each of the base wall 112 and one of the first and second side walls 108, 110, the first end wall 104 and each of the first and second side walls 108, 110, the second end wall 106 and each of the first and second side walls 108, 110, and the support panel 120 and each of the first and second side walls 108, 110, as examples. In the third step 306, the remaining spiral wall connectors 150 installed to secure the basket body 102 in the assembled configuration may include spiral wall connectors 150 configured to couple the base wall 112 and the other of the first and second side walls 108, 110 and the base wall 112 to each of the first end wall 104 and the second end wall 106, as examples.

The method 300 may include additional steps such as positioning the assembled ballasted solar mounting system 100 in a desired location, adding a ballast material (e.g., quarry rocks) to the assembled basket body 102, adjusting one or more of the first and second telescoping tubes 194, 210, the cross member 248, and the mounting element 272 relative to the first and second vertical tubes 156, 158 and/or one another, and coupling the mounting element 272 to the solar interface system 156, as examples. Additional steps relating to providing and assembling a plurality of ballasted solar mounting systems 100 and installing a plurality of solar interface installations 156 may also be included.

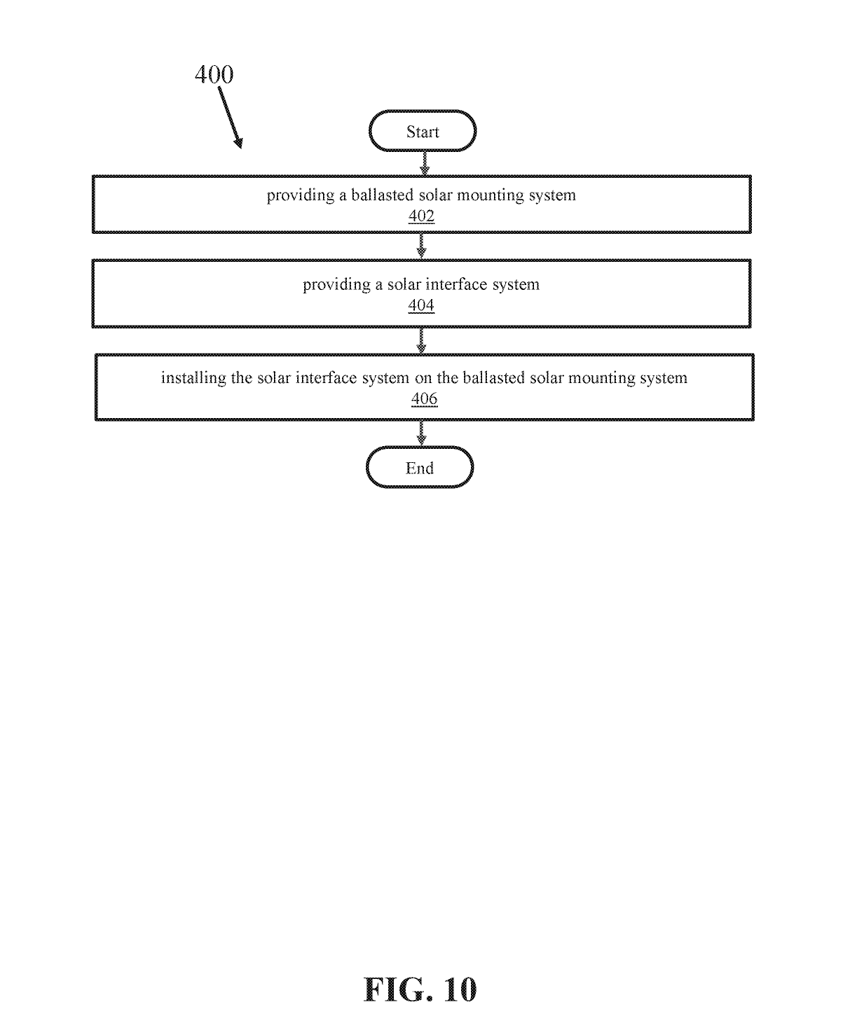

A method 400 of using a ballasted solar mounting system 100 is further provided, as shown in FIG. 10. The method 400 may include a first step 402 of providing the ballasted solar mounting system 100, as shown and described herein. A second step 404 may include providing a solar interface system 156, and a third step 406 may include installing the solar interface system 156 on the ballasted solar mounting system 100. Additional steps may include positioning the assembled ballasted solar mounting system 100 in a desired location, installing a ballast material in the basket body 102 of the ballasted solar mounting system 100, adjusting one or more of the first and second telescoping tubes 194, 210, the cross member 248, and the mounting element 272 relative to the first and second vertical tubes 156, 158 and/or one another, and providing and installing a plurality of ballasted solar mounting systems 100 and/or solar interface installations 156, as examples. It should be appreciated that one or more steps included in methods 300, 400 may be omitted, added, and/or repeated. Additionally, the order of the steps included in methods 300, 400 may be changed, as determined by one of skill in the art.

The ballasted solar mounting system 100 in the assembled configuration 116 may advantageously be used in combination with a locally sourced ballast material, such as quarry rocks, for example, thereby decreasing total assembly time and total cost. Examples of the ballast material include various rocks, stones, gravel, crushed stone, various natural and/or processed aggregates, including various non-natural materials such as crushed concrete and other recycled aggregates. Additionally, adjustments to the amount of ballast material used may be easily made during assembly and throughout operation as site requirements and/or environmental factors change. The basket body 102 including the spiral wall connectors 150 may allow the basket body 102 to be shipped in a flat, substantially preassembled configuration and setup quickly and easily by unfolding and positioning the basket body 102 using the hinges formed by the preassembled spiral wall connectors 150 and adding the remaining spiral wall connectors 150 to the basket body 102. Each of the support panel 120 and the cross support element 132 may provide enhanced structural support to the basket body 102. The basket body 102, fabricated using pre-galvanized, durable, lightweight material formed as wire sheets 128, may be easier and more cost effective with respect to shipping and assembly and capable of withstanding harsh environmental conditions.

The tube system 154 may be broken down into easy, efficient-to-ship parts for cost-effective shipping and may be easily assembled and easily coupled to each of the basket body 102 and the solar interface system 156 during assembly and installation. The combination of the basket body 102, the tube system 154, and the ballast material provides enhanced structural support for the solar interface system 156 that is durable, cost efficient, and easy to assemble, maintain, and adjust. Advantageously, the tube system 154 may be adjustable using the first and second telescoping tubes 194, 210, the cross member 248, and the mounting element 272, thereby allowing the ballasted solar mounting system 100 to be assembled in a desired configuration for optimizing solar output and enhancing structural support of the solar interface system 156.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A ballasted solar mounting system, comprising:
a basket body including:
a first end wall;
a second end wall configured to be disposed opposite the first end wall;
a first side wall configured to be disposed between each of the first end wall and the second end wall;
a second side wall configured to be disposed between each of the first end wall and the second end wall and opposite the first side wall;
a base wall having an outer edge, wherein each of the first end wall, the second end wall, the first side wall, and the second side wall are configured to extend upwardly from the outer edge of the base wall; and
a coupling mechanism configured to couple at least one of the first end wall, the second end wall, the first side wall, the second side wall, and the base wall to another one of the first end wall, the second end wall, the first side wall, the second side wall, and the base wall; and
a tube system including:
a first vertical tube;
a second vertical tube configured to be disposed opposite the first vertical tube;
a first telescoping tube configured to slidingly engage with the first vertical tube;
a second telescoping tube configured to slidingly engage with the second vertical tube; and
a cross tube configured to extend between the first vertical tube and the second vertical tube;
wherein the basket body and the tube system are configured to be removably coupled to one another.

2. The ballasted solar mounting system of claim 1, wherein the basket body includes a support panel configured to be disposed between the first end wall and the second end wall and configured to extend from the first side wall to the second side wall.

3. The ballasted solar mounting system of claim 1, wherein the basket body includes a pre-galvanized material formed into a wire sheet having a grid-like pattern.

4. The ballasted solar mounting system of claim 3, wherein the wire sheet includes a PVC coating.

5. The ballasted solar mounting system of claim 1, wherein the basket body includes a cross support element configured to extend from a first upper edge of the first side wall to a second upper edge of the second side wall.

6. The ballasted solar mounting system of claim 1, wherein the coupling mechanism includes a spiral wall connector.

7. The ballasted solar mounting system of claim 1, wherein the base wall is configured to rotate relative to one of the first side wall and the second side wall when the basket body is positioned in a flat configuration.

8. The ballasted solar mounting system of claim 1, wherein
the first vertical tube is configured to be coupled to the first end wall by
a first flat strap configured to abut an interior surface of the first end wall,
a first curved strap configured to abut the first vertical tube and an exterior surface of the first end wall, and
a first bracket fastener configured to extend through the first curved strap, the first end wall, and the first flat strap, and
the second vertical tube is coupled to the second end wall by
a second flat strap configured to abut an interior surface of the second end wall,
a second curved strap configured to abut the second vertical tube and an exterior surface of the second end wall, and
a second bracket fastener configured to extend through the second curved strap, the second end wall, and the second flat strap.

9. The ballasted solar mounting system of claim 1, wherein
the tube system includes a first support element configured to be disposed around an outer surface of the first vertical tube, and
each of the first vertical tube and the first support element includes at least one first telescoping tube aperture configured to receive a first telescoping tube fastener configured to secure the first telescoping tube in a desired position relative to the first vertical tube.

10. The ballasted solar mounting system of claim 9, wherein
the tube system includes a second support element disposed around an outer surface of the second vertical tube, and
each of the second vertical tube and the second support element includes at least one second telescoping tube aperture configured to receive a second telescoping tube fastener configured to secure the second telescoping tube in a desired position relative to the second vertical tube.

11. The ballasted solar mounting system of claim 1, wherein
a first end of the cross tube is configured to extend through a first cross tube opening disposed in the first vertical tube, and
a second end of the cross tube is configured to extend through a second cross tube opening disposed in the second vertical tube.

12. The ballasted solar mounting system of claim 1, wherein the cross tube is configured to extend through a first cutout formed in the first end wall, a second cutout formed in the second end wall, and a third cutout formed in the support panel.

13. The ballasted solar mounting system of claim 1, wherein the tube system includes a cross member configured to extend from a first end of the first telescoping tube adjacent a solar interface system to a second end of the second telescoping tube adjacent the basket body.

14. The ballasted solar mounting system of claim 13, wherein
the cross member includes a plurality of cross member coupling apertures disposed at each of a first end of the cross member and a second end of the cross member, and
the plurality of cross member coupling apertures disposed at the first end of the cross member is configured to align with a telescoping tube opening disposed at the first end of the first telescoping tube.

15. The ballasted solar mounting system of claim 14, wherein the tube system includes a mounting element configured to extend from the first telescoping tube to the second telescoping tube and couple the tube system to a solar interface system.

16. The ballasted solar mounting system of claim 15, wherein a position of each of the first telescoping tube, the second telescoping tube, the cross member, and the mounting element is adjustable.

17. A ballasted solar mounting system, comprising:
a basket body including:
a first end wall;
a second end wall disposed opposite the first end wall;
a first side wall disposed between each of the first end wall and the second end wall;
a second side wall disposed between each of the first end wall and the second end wall and opposite the first side wall;
a base wall having an outer edge, wherein each of the first end wall, the second end wall, the first side wall, and the second side wall extend upwardly from the outer edge of the base wall; and
a coupling mechanism coupling at least one of the first end wall, the second end wall, the first side wall, the second side wall, and the base wall to another one of the first end wall, the second end wall, the first side wall, the second side wall, and the base wall; and
a tube system including:
a first vertical tube;
a second vertical tube disposed opposite the first vertical tube;
a first telescoping tube slidingly engaged with the first vertical tube;
a second telescoping tube slidingly engaged with the second vertical tube; and
a cross tube extending between the first vertical tube and the second vertical tube;
wherein the basket body and the tube system are removably coupled to one another.

18. A method of assembling a ballasted solar mounting system, comprising:
providing a ballasted solar mounting system, the ballasted solar mounting system having;
a basket body in a flat configuration including:
a first end wall;
a second end wall configured to be disposed opposite the first end wall;
a first side wall configured to be disposed between each of the first end wall and the second end wall;
a second side wall configured to be disposed between each of the first end wall and the second end wall and opposite the first side wall;
a base wall having an outer edge, wherein each of the first end wall, the second end wall, the first side wall, and the second side wall are configured to extend upwardly from the outer edge of the base wall; and
a first coupling mechanism coupling at least one of the first end wall, the second end wall, the first side wall, the second side wall, and the base wall to another one of the first end wall, the second end wall, the first side wall, the second side wall, and the base wall; and
a tube system including:
a first vertical tube;
a second vertical tube configured to be disposed opposite the first vertical tube;
a first telescoping tube configured to slidingly engage with the first vertical tube;
a second telescoping tube configured to slidingly engage with the second vertical tube; and
a cross tube configured to extend between the first vertical tube and the second vertical tube;
unfolding the basket body;
installing a second coupling mechanism;
coupling the first vertical tube to the first end wall and the second vertical tube to the second
end wall;
coupling the cross tube to the first vertical tube and the second vertical tube;
coupling the first telescoping tube to the first vertical tube and the second telescoping tube to
the second vertical tube;
coupling the cross member to the first telescoping tube and the second telescoping tube; and
coupling the mounting element to the first telescoping tube and the second telescoping tube.

19. The method of claim 18, further including inserting a ballast material into the basket body.

20. The method of claim 18, including providing a ballasted solar mounting system according to claim 17 and coupling the ballasted solar mounting system to a solar interface system.
